(19) United States
(12) Patent Application Publication
(10) Pub. No.: US 2013/0226046 A1
(43) Pub. Date: Aug. 29, 2013

(54) J Walker Rehabilitation "Learn To Walk Again" System

(71) Applicant: John Gilbert Salazar, Espanola, NM (US)

(72) Inventor: John Gilbert Salazar, Espanola, NM (US)

(21) Appl. No.: 13/406,049

(22) Filed: Feb. 27, 2012

(51) Int. Cl. A61H 1/02

(52) U.S. Cl. 601/23

(57) ABSTRACT

The J Walker Rehabilitation “Learn to Walk Again” System is the first of its kind, portable and affordable piece of rehabilitation equipment designed for physical therapy centers and home use. The J Walker is an advanced parallel bar incorporating a unique overhead Travel Bar and Travel Ring System with a harness designed to support patient during therapy. The harnessed patient is attached to the Travel Ring that runs along the Travel Bar. Whether marching in place, taking first steps, or performing more difficult movements, patients can exercise safely in the care of a therapist or caregiver. If the patient loses balance or strength, the harness prevents the patient from falling. The J Walker is equipped with vertical and horizontal adjustable handrails. Handrails are adjusted based on the patient's arm length for optimal comfort. The J Walker has locking wheels that can be rolled to any desired location.

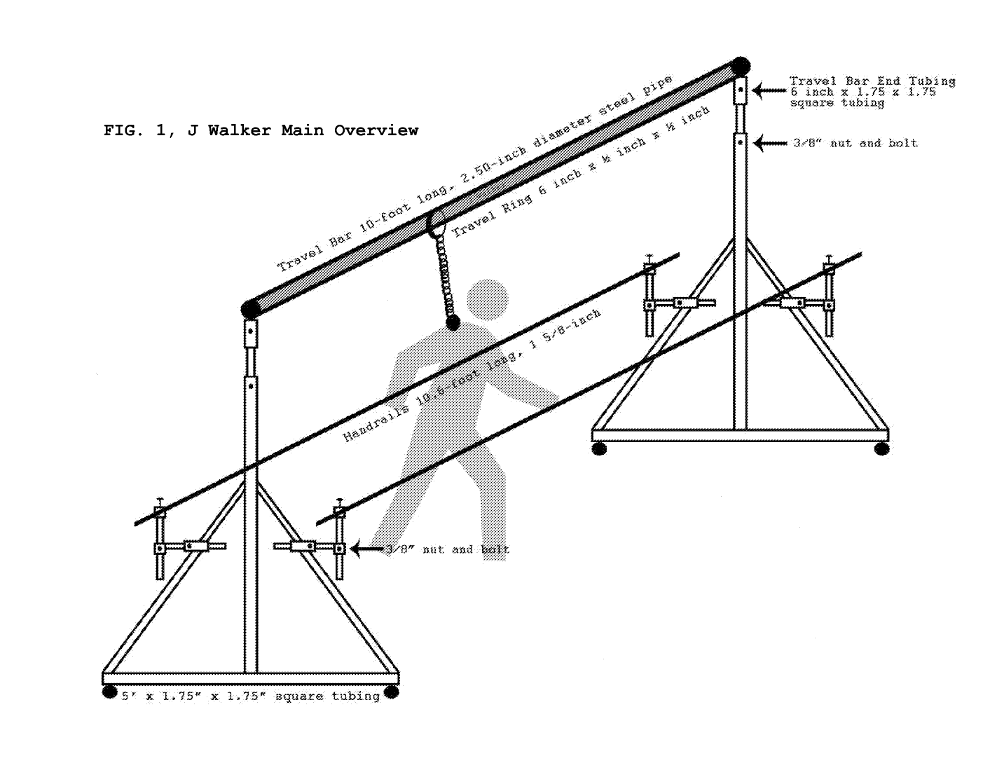

The J Walker Rehabilitation “Learn to Walk Again” System is a rehabilitation apparatus designed to help people with leg trauma resulting from spinal cord injury, fracture, muscular disease, circulatory problems, etc. (see FIG. 1 and Ill. 1).

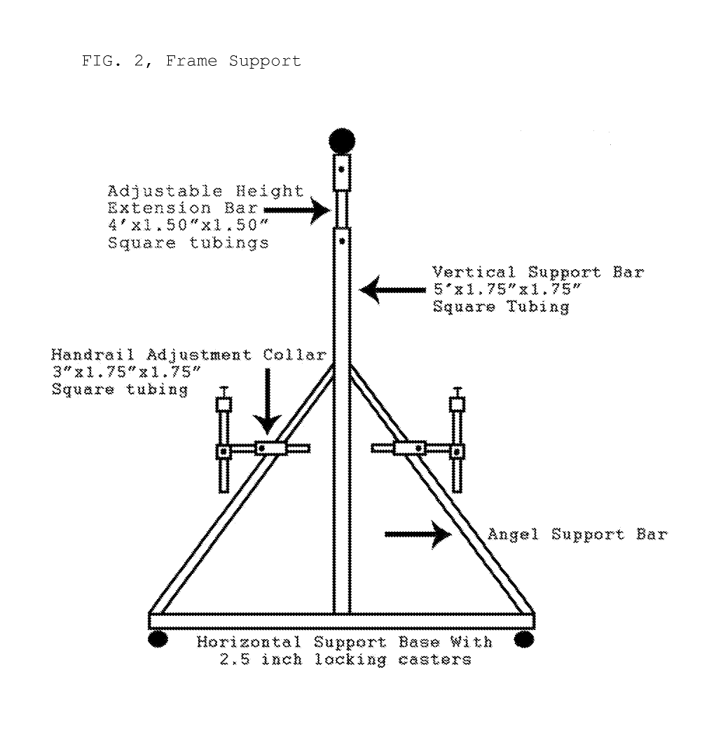

The J Walker is made of steel. It has two frame supports on each end. Each frame support consists of one horizontal base, two angle supports, and one center vertical support. Each horizontal base is five feet long and constructed of 1.75 inch square tubing. The angle supports are four feet long and constructed of 1.5 inch square tubing. Each center support is five feet long and constructed of 1.75 inch square tubing with 0.50 inch center drilled holes for adjustments. Each horizontal base is equipped with two 2.5 inch locking wheels (see FIG. 2).

Each angle support is fitted with a handrail adjustment collar. Vertical and horizontal handrail adjustment bars are fitted into each collar. These allow the handrails to be adjusted up and down or in and out. The collars are three inches long and constructed of 1.75 inch square tubing (see FIG. 3).

The in and out horizontal bar is comprised of two parts. The main bar is one foot long and constructed of 1.5 inch square tubing. Welded at one end in the vertical position is a three inch long piece constructed on 1.75 inch square tubing. The one foot piece slides into the adjustment collar and secured with a 2.5 inch×0.375 (⅜) inch nut and bolt. All these pieces have center drilled holes to accommodate in and out adjustments (see FIG. 3).

The up and down vertical adjustment bar is one foot long and constructed with 1.5 inch square tubing. It has 0.50 inch center drilled holes for making height adjustments (see FIG. 3).

A rail collar to hold the handrails is welded to the top of each vertical adjustment bar. Each rail collar is a 2 inch×2 inch square tube with a 0.25 inch hole drilled in the top center to accommodate a locking pin to hold the handrail in place (see FIG. 3).

The J Walker is equipped with adjustable height extension bars that fit into the center frame support bar (see FIG. 2). Each height extension bar is four feet long and constructed of 1.5 inch square tubing with 0.50 inch center drilled holes for vertical adjustment. The bar slides up or down in the center of the vertical frame support. The extension bar is locked with 2.5 inch×0.375 (⅜) inch nuts and bolts. The height can range from five feet six inches to seven feet six inches.

The J Walker is unique because of the “Travel Bar and Travel Ring System.” The travel bar is an overhead ten foot long, two and half inch diameter steel pipe. The travel bar is welded to the travel bar end tubing at each end. The end tubing is six inches long and constructed of 1.75 inch square tubing (see FIG. 1). The end tubing slips into the height extension bar and is locked with a 2.5 inch×0.375 (⅜) inch nut and bolt.

The steel “Travel Ring” slips into the “Travel Bar” and glides freely along its surface length. The “Travel Ring” is five inches in diameter and 0.5×0.5 inches in width (see FIG. 1 and Ill. 2 and 3). The frame construction is now complete.

A 1000 pound threaded chain link or locking carabiner is hooked to the “Travel Ring.” Attached to the same link or carabiner is a 30 inch chain. Another carabiner is hooked to the bottom of the chain. This carabiner serves to attach the harness worn by the patient.

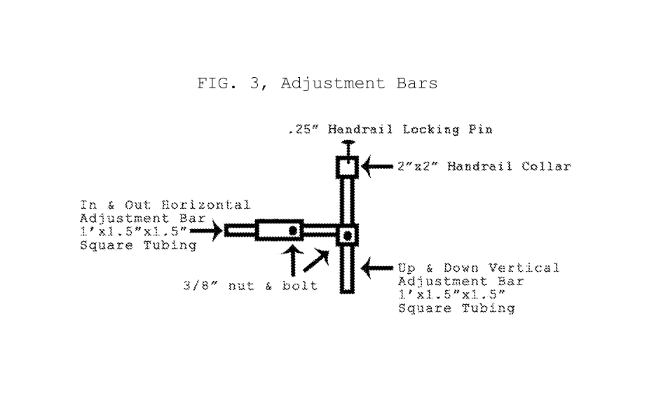

The patient's harness is a heavy industrial harness with three securing buckles, one buckles the chest and one on each thigh (see FIGS. 4, 5).

The J Walker is equipped with locking handrails that can be adjusted up or down, in or out, to accommodate the patient's arm length. The handrails are ten feet, six inches long by 1⅝ diameter width with ⅜ holes to accommodate the locking pins. To enter or egress the J Walker, the therapist or caregiver removes the rail locking pin and slides the rail out from the rail collar enough to accommodate the patient (˜3 ft). A handrail stand/foot and adjusting seat are also available.

1. The J Walker Rehabilitation “Learn to Walk Again” System is a portable and affordable piece of rehabilitation equipment designed for both rehabilitation centers and home use.

2. The J Walker is an advanced parallel bar with the first of its kind overhead Travel Bar and Travel Ring System with height adjustable extension bar and harness designed to support safely the patient's weight during physical therapy.

3. The J Walker Travel Ring glides along the Travel Bar surface and allows the patient to walk freely and with confidence.

4. The J Walker is also equipped with vertical and horizontal adjustable handrails. Handrails are adjusted based on the patient's arm length for optimal comfort.

5. The J Walker has a locking wheel system that can be rolled easily to any desired location.
